(19) United States
(12) Patent Application Publication
(10) Pub. No.: US 2018/0080545 A1
(43) Pub. Date: Mar. 22, 2018

(54) DIRECTIONAL VALVE FOR MULTI-PRESSURE HYDRAULIC CONTROL SYSTEM

(71) Applicant: BorgWarner Inc., Auburn Hills, MI (US)

(72) Inventors: Chengyun GUO, Novi, MI (US); Christopher A. SPANGLER, Rochester Hills, MI (US); Dmitriy SEMENOV, Rochester Hills, MI (US)

(21) Appl. No.: 15/566,831

(22) PCT Filed: Apr. 11, 2016
(86) PCT No.: PCT/US2016/026913

§ 371 Date: Oct. 16, 2017

Related U.S. Application Data
(60) Provisional application No. 62/148,785, filed on Apr. 17, 2015.

(51) Int. Cl. F16H 61/00; F16H 61/4061

(52) U.S. Cl. CPC F16H 61/0025; F16H 2061/0037; F16H 61/4061

(57) ABSTRACT

A directional valve (78, 178) for use with a multi-pressure hydraulic control system (66, 166) of a vehicle powertrain system (10) includes a valve member (80, 180) receiving at least three separate outputs of fluid pumped by at least one pump (28) for allowing the at least three separate outputs to be selectively combined and/or separated, the valve member (80, 180) being movable between at least three positions that produces fluid outputs having fluid pressures of a high fluid pressure, a medium fluid pressure, and a low fluid pressure to one or more portions of the hydraulic control system (66, 166).

### CROSS-REFERENCE TO RELATED APPLICATION(S)

The present application claims priority to and all the benefits of U.S. Provisional Patent Application No. 62/148,785, filed on Apr. 17, 2015, which is hereby expressly incorporated herein by reference in its entirety.

### BACKGROUND OF INVENTION

### 1. Field of Invention

The present invention relates generally to powertrain systems and, more specifically, to a directional valve for a multi-pressure hydraulic control system for a powertrain system.

### 2. Description of the Related Art

Conventional vehicle powertrain systems known in the art typically include an engine in rotational communication with a transmission. The engine generates rotational torque which is selectively translated to the transmission which, in turn, translates rotational torque to one or more wheels. The transmission multiplies the rotational speed and torque generated by the engine through a series of predetermined gear sets, whereby changing between the gear sets enables a vehicle to travel at different vehicle speeds for a given engine speed. Thus, the gear sets of the transmission are configured such that the engine can operate at particularly desirable rotational speeds so as to optimize performance and efficiency.

In addition to changing between the gear sets, the transmission is also used to modulate engagement with the engine, whereby the transmission can selectively control engagement with the engine so as to facilitate vehicle operation. By way of example, torque translation between the engine and transmission is typically interrupted while the vehicle is parked or idling, or when the transmission changes between the gear sets. In conventional automatic transmissions, modulation is achieved via a hydrodynamic device such as a hydraulic torque converter. However, modern automatic transmissions may replace the torque converter with one or more electronically and/or hydraulically actuated clutches (sometimes referred to in the art as a “dual clutch” automatic transmission). Automatic transmissions are typically controlled using hydraulic fluid, and include a pump assembly, one or more solenoid valves, and an electronic controller. The pump assembly provides a source of fluid power to the solenoid valves which, in turn, are actuated by the controller so as to selectively direct hydraulic fluid throughout the automatic transmission to control modulation of rotational torque generated by the engine. The solenoid valves are also typically used to change between the gear sets of the automatic transmission, and may also be used to control hydraulic fluid used to cool and/or lubricate various components of the transmission in operation.

Depending on the specific configuration of the automatic transmission, clutch modulation and/or gear actuation may necessitate operating the pump assembly so as to pressurize the hydraulic fluid at relatively high magnitudes. Conversely, lubrication and/or cooling typically require significantly lower hydraulic fluid pressure, whereby excessive pressure has a detrimental effect on transmission operation and/or efficiency. Moreover, hydraulic fluid heats up during operation of the automatic transmission, and changes in the temperature of the hydraulic fluid result in a corresponding change in the viscosity of the hydraulic fluid. As such, where specific hydraulic pressure is needed to properly operate the automatic transmission, the volume of hydraulic fluid required to achieve the requisite hydraulic pressure varies with operating temperature. Further, where the pump assembly is driven by the powertrain, fluid flow is proportional to pump rotational speed. Because fluid flow increases with increased rotational speed, under certain operating conditions, a significant volume of fluid displaced by the pump assembly must be re-circulated to maintain proper fluid flow and pressure requirements throughout the automatic transmission, thereby leading to disadvantageous parasitic loss which results in low efficiency.

Each of the components and systems of the type described above must cooperate to effectively modulate translation of rotational torque from the engine to the wheels of the vehicle. In addition, each of the components and systems must be designed not only to facilitate improved performance and efficiency, but also so as to reduce the cost and complexity of manufacturing the vehicles.

The efficiency of the hydraulic control system for a powertrain system can be improved through the usage of one or more pumps with multiple output ports that feed different portions of the hydraulic control system with fluid that is at different pressure levels and different flow rates. However, there is a need in the art to provide a directional valve that allows the outputs of one or more pumps to be selectively combined or separated to meet any flow demand portion of the system at a given operating condition.

### SUMMARY OF THE INVENTION

The present invention provides a directional valve for use with a multi-pressure hydraulic control system of a vehicle powertrain system. The directional valve includes a valve member receiving at least three separate outputs of fluid pumped by at least one pump for allowing the at least three separate outputs to be selectively combined and/or separated. The valve member is movable between at least three positions that produce fluid outputs having fluid pressures of a high fluid pressure, a medium fluid pressure, and a low fluid pressure to one or more portions of the hydraulic control system.

In addition, the present invention provides a method for controlling a directional valve of a multi-pressure hydraulic control system of a vehicle powertrain system. The method includes the steps of providing a directional valve having a valve member being movable between at least three positions. The method also includes the steps of receiving at least three separate outputs of fluid pumped by at least one pump with the valve member, and moving the valve member between the at least three positions to produce fluid outputs having a high fluid pressure, a medium fluid pressure, and a low fluid pressure to one or more portions of the hydraulic control system.

One advantage of the present invention is that a new directional valve is provided for a multi-pressure hydraulic control system that is used to selectively combine and separate the multiple flow branches with different pressure levels with equal or different flow rates for the hydraulic control system. Another advantage of the present invention is that the efficiency of the multi-pressure hydraulic control system for a powertrain system is improved through the use of such directional valve and a pump(s) with multiple pressure and flow rate. Yet another advantage of the present invention is that the directional valve allows the outputs of the pump(s) to be selectively combined or separated to meet any flow demand portion of the system at a given operating condition.

### BRIEF DESCRIPTION OF THE DRAWINGS

Other objects, features, and advantages of the present invention will be readily appreciated as the same becomes better understood after reading the subsequent description taken in connection with the accompanying drawings wherein:

FIG. 1 is a schematic view of a vehicle powertrain system including a directional valve, according to the present invention;

FIG. 2 is a schematic view of a first embodiment of a multi-pressure hydraulic control system for use with the directional valve of FIG. 1; and.

FIG. 3 is a schematic view of a second embodiment of a multi-pressure hydraulic control system for use with the directional valve of FIG. 1.

### DETAILED DESCRIPTION OF THE INVENTION

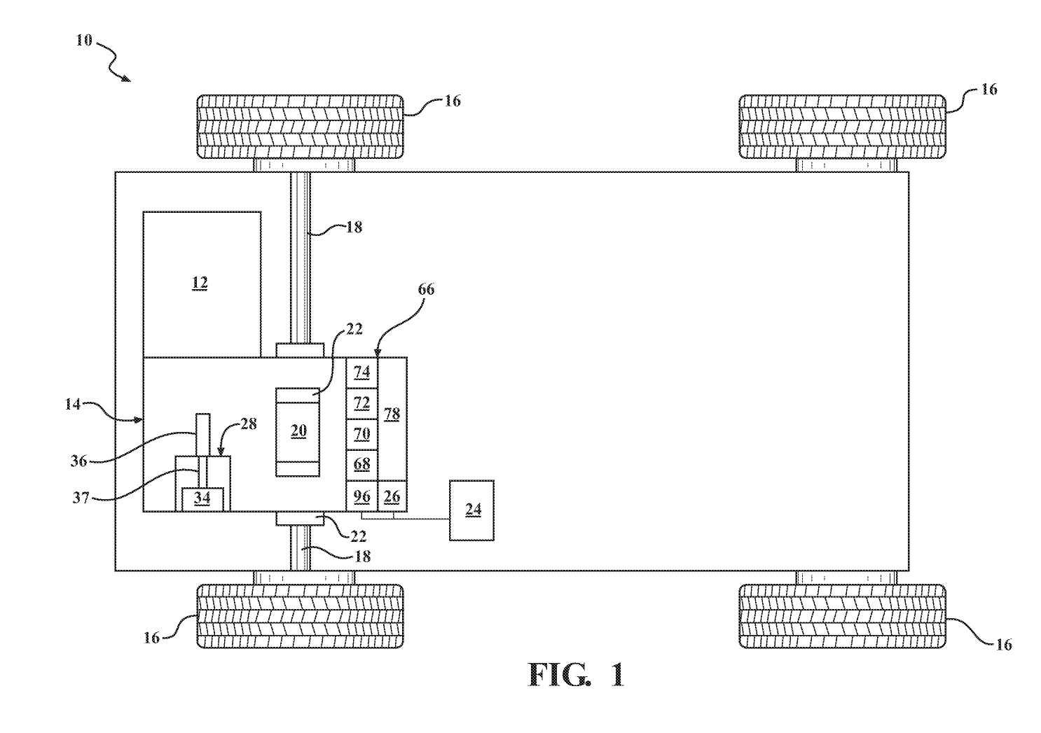

Referring now to the figures, where like numerals are used to designate like structure unless otherwise indicated, a vehicle powertrain system is schematically illustrated at 10 in FIG. 1. The powertrain system 10 includes an engine 12 in rotational communication with an automatic transmission 14. The engine 12 generates rotational torque which is selectively translated to the automatic transmission 14 which, in turn, translates rotational torque to one or more wheels, generally indicated at 16. To that end, a pair of continuously-variable joints 18 translates rotational torque from the automatic transmission 14 to the wheels 16. It should be appreciated that the engine 12 and the automatic transmission 14 of FIG. 1 are of the type employed in a conventional “transverse front wheel drive” powertrain system 10. It should also be appreciated that the engine 12 and/or the automatic transmission 14 could be of any suitable type, configured in any suitable way sufficient to generate and translate rotational torque so as to drive the vehicle, without departing from the scope of the present invention.

The automatic transmission 14 multiplies the rotational speed and torque generated by the engine 12 through a series of predetermined gear sets 20 (not shown in detail, but generally known in the art), whereby changing between the gear sets 20 enables the vehicle to travel at different vehicle speeds for a given speed of the engine 12. Thus, the gear sets 20 of the automatic transmission 14 are configured such that the engine 12 can operate at particularly desirable rotational speeds so as to optimize vehicle performance and efficiency. In addition to changing between the gear sets 20, the automatic transmission 14 is also used to modulate engagement with the engine 12, whereby the automatic transmission 14 can selectively control engagement with the engine 12 so as to facilitate vehicle operation. By way of example, torque translation between the engine 12 and the automatic transmission 14 is typically interrupted while the vehicle is parked or idling, or when the transmission 14 changes between the gear sets 20. In the automatic transmission 14, modulation of rotational torque between the engine 12 and the automatic transmission 14 is achieved via a hydrodynamic device such as a hydraulic torque converter (not shown, but generally known in the art). An example of the automatic transmission 14 is disclosed in U.S. Pat. No. 8,375,816 to Braford, Jr., the disclosure of which is hereby incorporated by reference in its entirety. It should be appreciated that the automatic transmission 14 is adapted for use with vehicles such as automotive vehicles, but could be used in connection with any suitable type of vehicle.

Irrespective of the specific configuration of the powertrain system 10, the automatic transmission 14 is typically controlled using hydraulic fluid. Specifically, the automatic transmission 14 is cooled, lubricated, actuated, and modulates torque using hydraulic fluid. To these ends, the automatic transmission 14 typically includes a controller 24 in electrical communication with one or more solenoids 26 (see FIG. 1) used to direct, control, or otherwise regulate flow of fluid throughout the transmission 14, as described in greater detail below. In order to facilitate the flow of hydraulic fluid throughout the automatic transmission 14, the powertrain system 10 includes at least one or more pumps, generally indicated at 28. In one embodiment, the pump 28 may be a positive displacement pump assembly as disclosed in DKT14308A, the disclosure of which is hereby incorporated by reference in it entirety. It should be appreciated that either a three-output pump 28, three independent pumps 28, or three coaxially driven pumps 28, or any combination of pumps 28 that provides three separate output ports may be used.

The pump 28 is adapted to provide a source of fluid power to the powertrain system 10. Specifically, the pump 28 provides fluid power to various locations and components of the automatic transmission 14, as described in greater detail below. While the pump 28 is described herein as providing fluid power to the automatic transmission 14 of the powertrain system 10, those having ordinary skill in the art will appreciate that the pump 28 could be used in connection with any suitable part of the powertrain system 10 without departing from the scope of the present invention. By way of non-limiting example, the pump 28 of the present invention could be used to direct or otherwise provide a source of fluid power to the engine 12, a transfer case (not shown, but generally known in the art), or any other component or system of the powertrain system 10 that utilizes fluid for lubrication, cooling, control, actuation, and/or modulation.

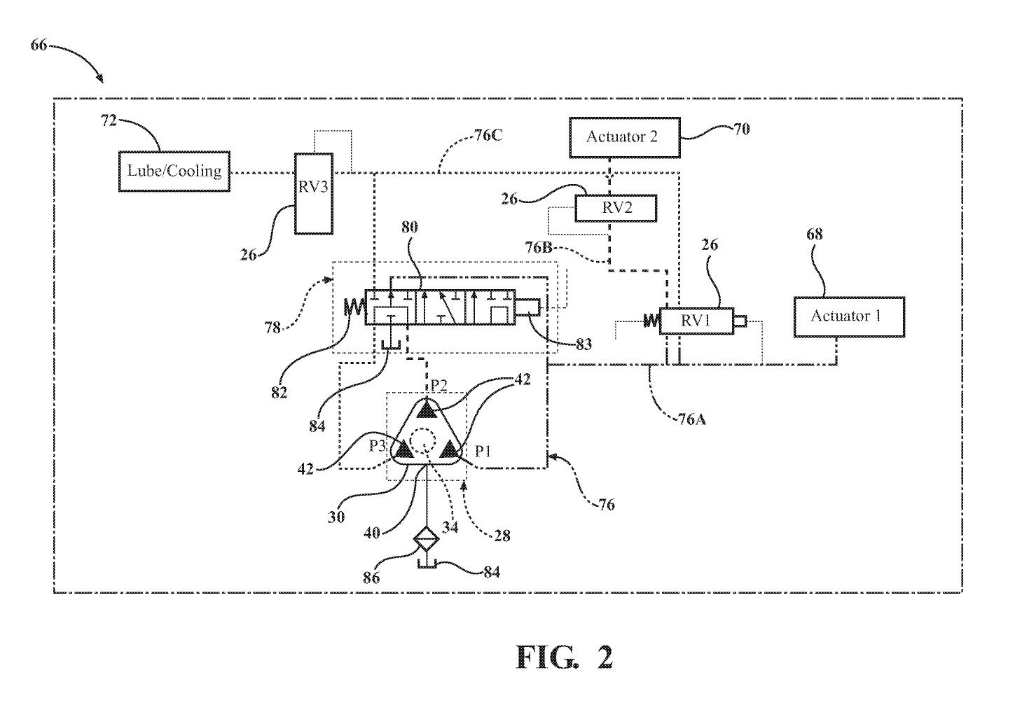

In one embodiment, the pump 28 includes a stator 30 having a chamber and a rotatable pump member 34 disposed in the chamber of the stator 30 (FIG. 2). The pump member 34 is disposed in torque translating relationship with the powertrain system 10. More specifically, the pump member 34 receives rotational torque from a prime mover 36 (not shown in detail, but generally known in the art) of the powertrain system 10. In the representative embodiment illustrated herein, the pump member 34 is coupled to an input shaft 37 which, in turn, is disposed in rotational communication with the prime mover 36. However, those having ordinary skill in the art will appreciate that the pump 28 could be configured differently, with or without the use of an input shaft 37, without departing from the scope of the present invention. Moreover, it should be appreciated that the pump member 34 could receive rotational torque from the powertrain system 10 in a number of different ways. By way of non-limiting example, the pump member 34 could be directly coupled to the prime mover 36, or one or more geartrains (not shown in detail, but generally known in the art) could be interposed between the pump member 34 and the prime mover 36 so as to adjust the rotational speed and torque therebetween.

In the representative embodiment illustrated herein, the pump 28 is disposed in rotational communication with the prime mover 36 that is supported in the automatic transmission 14. However, those having ordinary skill in the art will appreciate that the prime mover 36 could be realized by any suitable component of the powertrain system 10 without departing from the scope of the present invention. By way of non-limiting example, the prime mover 36 could be realized by a shaft supported in rotational communication with the engine 12 and/or the automatic transmission 14, or the prime mover 36 could be a shaft of an electric motor (not shown, but generally known in the art).

As noted above, each pump 28 includes at least one inlet region or port 40 for receiving fluid to be pumped by the pump member 34 and at least one outlet region or port 42 for outputting fluid pumped by the pump member 34. In one embodiment illustrated in FIG. 2, a single pump 28 has one inlet region 40 and three outlet regions 42. Rotation of the pump member 34 within the chamber displaces fluid such that each of the outlet regions 42 provides a respective and separate source of fluid power to the powertrain system 10. It should be appreciated that the pump 28 can be configured in a number of different ways.

As noted above, the present invention is directed toward a directional valve 78, according to the present invention, for a multi-pressure hydraulic control system, generally indicated at 66, for use with the automatic transmission 14. The multi-pressure hydraulic control system 66 directs or otherwise controls fluid power from the outlet regions 42 of the pump 28 to the powertrain system 10, as described in greater detail below. It will be appreciated that the multi-pressure hydraulic control system 66 can be configured in a number of different ways to direct fluid to the automatic transmission 14. By way of non-limiting example, two different embodiments of the multi-pressure hydraulic control system 66 for use with the directional valve 78 are described herein, each being configured to direct fluid to the automatic transmission 14 in different ways. For the purposes of clarity and consistency, unless otherwise indicated, subsequent discussion of the multi-pressure hydraulic control system 66 will refer to a first embodiment of the multi-pressure hydraulic control system 66 for use with the directional valve 78 as shown in FIG. 2.

Referring now to FIG. 2, a first embodiment of the multi-pressure hydraulic control system 66, directional valve 78, and pump 28 is shown in connection with the automatic transmission 14. As noted above, the automatic transmission 14 utilizes hydraulic fluid for lubrication, actuation, modulation, and/or control. To that end, the automatic transmission 14 includes a first actuation portion or circuit 68, a second actuation portion or circuit 70, a lubrication/cooling portion or circuit 72. The first actuation circuit 68 is used to selectively actuate an actuator such as a clutch in a step automatic transmission. The second actuation circuit 70 is used to selectively actuate an actuator such as the torque converter in a step automatic transmission. The lubrication/cooling circuit 72 is used for cooling and lubrication to other locations throughout the automatic transmission 14, such as shafts, bearings, gears, and the like (not shown in detail, but generally known in the art). Those having ordinary skill in the art will appreciate that there are a number of different ways that the circuits 68, 70, 72 described above could be configured. As such, each of the circuits 68, 70, 72 is depicted generically. Moreover, it should be appreciated that the multi-pressure hydraulic control system 66 and directional valve 78 could be used to direct fluid power to any suitable number of circuits, configured in any suitable way and for any suitable purpose of the powertrain system 10, without departing from the scope of the present invention. Similarly, while the representative embodiments illustrated herein describe the multi-pressure hydraulic control system 66 and directional valve 78 as used with hydraulic fluid in the automatic transmission 14, it should be appreciated that the multi-pressure hydraulic control system 66, directional valve 78, and pump 28 can be adapted to displace or otherwise direct any suitable type of fluid to any suitable component or system of the powertrain system 10 of any suitable type or configuration without departing from the scope of the present invention.

Those having ordinary skill in the art will appreciate that each of the circuits 68, 70, 72 may require respectively different pressure and/or flow requirements. In one embodiment, the multi-pressure hydraulic control system 66 requires three different pressure levels. By way of non-limiting example, in the representative embodiment of the multi-pressure hydraulic control system 66 described herein, the first actuation circuit 68 requires a relatively high or first hydraulic fluid pressure (for example, ˜15-20 bar). This pressure can be required in the automatic transmission 14, for example, for a variator of a continuously variable (automatic) transmission or clutch and gear actuation systems for a dual clutch automatic transmission or a step-gear automatic transmission. This portion of the system requires often only a small flow rate of fluid in steady state operation, but will require large flow rates of fluid when doing actuations. The second actuation circuit 70 requires a medium or second hydraulic fluid pressure (for example, ˜2 bar). This pressured can be required in the automatic transmission 14, for example, for a torque converter in a continuously variable automatic transmission or a step-gear automatic transmission, or clutch cooling portion of the circuit for a dual clutch automatic transmission or step-gear automatic transmission. Similar to the high pressure circuit, this portion usually only requires a low flow rate of fluid in normal operation. However, during and after the high energy shift events (or launch events), the clutch will require a high flow rate (up to 20 LPM) to ensure that the friction interface is quickly reduced in temperature. The lubrication/cooling circuit 72 requires a low or third hydraulic fluid pressure (for example, <0.5 bar) for cooling and lubricating. This pressure can be required in the automatic transmission 14, for example, for a variator and chain/belt lubrication in a continuously variable (automatic) transmission, or gearbox lubrication in a dual clutch automatic transmission or a step-gear automatic transmission. It should be appreciated that this portion of the system requires a flow rate dependent on the speed, torque, and temperature that the automatic transmission 14 is operating at.

To facilitate the competing flow and pressure requirements of the circuits 68, 70, 72, the multi-pressure hydraulic control system 66 includes fluid lines, generally indicated at 76, and a directional or switching valve, according to the present invention and generally indicated at 78, that cooperate with the pump 28. One fluid line 76A of the fluid lines 76, also known as a main line, is disposed in fluid communication with one of the outlet regions 42 of the pump 28, the directional valve 78, and the first actuation circuit 68. The first actuation circuit 68 has the highest relative hydraulic fluid pressure requirements of the automatic transmission 14. Another fluid line 76B of the fluid lines 76 is disposed in fluid communication with the directional valve 78 and the second actuation circuit 70. The second actuation circuit 70 has the medium hydraulic fluid pressure requirements of the automatic transmission 14. Yet another fluid line 76C is disposed in fluid communication with the directional valve 78 and the lubrication/cooling circuit 72. The lubrication/cooling circuit 72 has the low hydraulic fluid pressure requirements of the automatic transmission 14. It should be appreciated that the fluid lines 76 could be defined in any suitable way, disposed in fluid communication with any suitable component or circuit of the multi-pressure hydraulic control system 66, without departing from the scope of the present invention.

The directional valve 78 includes a movable valve member 80 having at least three positions such as a first position, a second position, and a third position. In one embodiment, the directional or switching valve 78, according to the present invention, is a six-way, three position valve. At one end of the directional valve 78, the valve member 80 is biased by a spring 82 and a possible pressure signal. At the other end of the directional valve 78, the valve member 80 has a hydraulic inlet 83 that is controlled by another signal, which can be a pressure signal from another solenoid 26 or an electrical signal. In this embodiment, when the valve member 80 of the directional valve 78 is in the first or right position, fluid power from one of the outlet regions 42 is directed to the fluid line 76A and fluid power from the other two outlet regions 42 is directed away from the fluid line 76A to provide the low or third hydraulic fluid pressure. When the valve member 80 of the directional valve 78 is in the second or mid position, fluid power from two of the outlet regions 42 is directed to the fluid line 76A and fluid power from the other outlet region 42 is directed away from the fluid line 76A to provide the medium or second hydraulic fluid pressure. When the valve member 80 of the directional valve 78 is in the third or left position, fluid power from all three of the outlet regions 42 is directed to the fluid line 76A to provide the high or first hydraulic fluid pressure. The valve member 80 of the directional valve 78 is selectively moveable between the positions so as to control flow of fluid power from the outlet regions 42 of the pump 28 to the fluid line 76A. It should be appreciated that the directional valve 78 has the ability to selectively control the three outputs of the pump 28 to meet the flow and pressure demands of all portions of the multi-pressure hydraulic control system 66 while also minimizing wasted energy.

As will be appreciated from the subsequent description below, the positions of the valve member 80 of the switching valve 78 described above enable the pump 28 to selectively combine and/or separate fluid power from the three outlet regions 42 in predetermined ways so as to ensure proper hydraulic fluid pressure at the fluid line 76A under different operating conditions of the automatic transmission 14. In the exemplary embodiment of the positions described above and illustrated in FIG. 2, the directional valve 78 of the multi-pressure hydraulic control system 66 directs fluid power from all three outlet regions 42 to the fluid line 76A when the valve member 80 of the directional valve 78 is in the third position. However, those having ordinary skill in the art will appreciate that the automatic transmission 14 and/or multi-pressure hydraulic control system 66 could have significantly different operating requirements, depending on the application. It should be appreciated that the directional valve 78 could be configured with any suitable number of positions adapted to direct fluid from the pump 28 in a number of different ways, without departing from the scope of the present invention.

In one embodiment, the multi-pressure hydraulic control system 66 includes a sump 84 for providing a source of hydraulic fluid to the inlet region(s) 40 of the pump 28. More specifically, the sump 84 is adapted to store non-pressurized hydraulic fluid and is disposed in fluid communication with all inlet region(s) 40 of the pump 28. However, while the multi-pressure hydraulic control system 66 depicted herein utilizes a common sump 84 for all inlet regions 40, it should be appreciated that a plurality of sumps 84 could be utilized. By way of non-limiting example, each inlet region 40 could be disposed in fluid communication with a different sump (not shown, but generally known in the art). In one embodiment, when the valve member 80 of the directional valve 78 is in the first position and/or the second position, fluid power is at least partially directed to the sump 84. Similarly, when the valve member 80 of the directional valve 78 is in the first position and/or the second position, fluid power is at least partially directed to the second actuation circuit 70 and/or to the lubrication/cooling circuit 72.

As noted above, the directional valve 78 of the multi-pressure hydraulic control system 66 directs hydraulic fluid from a common sump 84. In order to ensure long life of the automatic transmission 14, a suction filter 86 may be disposed in fluid communication between the sump 84 and the inlet region(s) 40 of the pump 28. The suction filter 86 protects the pump 28 from particulates and other contamination that may accumulate in the hydraulic fluid. Likewise, a pressure filter (not shown) may be disposed between the directional valve 78 and one or more of the circuits 68, 70, 72 so as to provide additional filtering protection from contamination, such as particulates deposited in the hydraulic fluid by the pump 28. Similarly, one or more additional auxiliary filters (not shown) may be used to protect the solenoid valves 26 from contamination.

As noted above, the multi-pressure hydraulic control system 66 may include a controller 24 in electrical communication with one or more solenoid valves 26 used to control the directional valve 78. The controller 24, via the solenoid valve 26, controls the directional valve 78, whereby the solenoid valve 26 is interposed in fluid communication between the fluid line 76A and the hydraulic inlet 83. More specifically, in this embodiment, the solenoid valve 26 is realized as a proportioning solenoid valve adapted to move the valve member 80 of the directional valve 78 between the positions. To that end, the controller 24 is adapted to actuate the proportioning solenoid valve so as to selectively move the directional valve 78 between the positions. While a proportioning-style valve is described herein, it will be appreciated that there are many different types of solenoid valves 26 known in the related art. Thus, the proportioning valve could be of any suitable type, controlled in any suitable way, without departing from the scope of the present invention. By way of non-limiting example, solenoid valves 26 are known in the related art that may be cycled, such as by pulse width modulation (PWM), or may include variable position functionality, actuated such as with a stepper motor or an additional solenoid (not shown, but generally known in the art).

The controller 24, sometimes referred to in the related art as an “electronic control module,” may also be used to control other components of the automatic transmission 14. Further, in one embodiment, the multi-pressure hydraulic control system 66 includes at least one sensor 96 disposed in fluid communication with the fluid line 76A and disposed in electrical communication with the controller 24 (electrical connection not shown in detail, but generally known in the art). The sensor 96 generates a signal representing at least one of hydraulic pressure, temperature, viscosity, and/or flowrate. The controller 24 may be configured to monitor the sensor 96 to move the directional valve 78 between the positions. In one embodiment, the sensor 96 is a pressure transducer for generating a signal representing the hydraulic fluid pressure occurring at the fluid line 76A. While a single sensor 96 is utilized in the representative embodiment illustrated herein, it should be appreciated that the multi-pressure hydraulic control system 66 could include any suitable number of sensors, of any suitable type, arranged in any suitable way, without departing from the scope of the present invention.

The summary of positions for fluid flow of the directional valve 78 illustrated in FIG. 2 is as follows:

| Directional Valve State | P1 | P2 | P2 |
|---|---|---|---|
| Left position | Actuator 1 | Actuator 1 | Actuator 1 |
| Mid position | Actuator 1 | Actuator 1 | Lube/Cooling |
| Right position | Actuator 1 | Sump | Lube/Cooling |

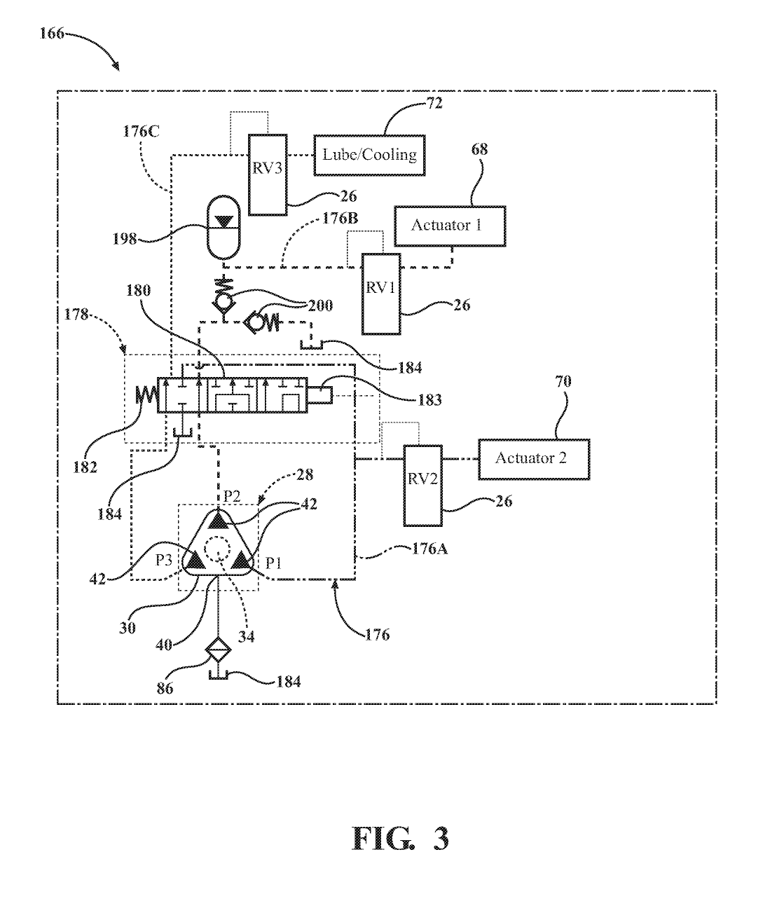

As noted above, a second embodiment of the multi-pressure hydraulic control system 66 for use with the directional valve 78 of the present invention is shown in FIG. 3. In the description that follows, like components of the second embodiment of the multi-pressure hydraulic control system are provided with the same reference numerals used in connection with the first embodiment of the multi-pressure hydraulic control system 66, and different components are provided with reference numerals increased by one hundred (100).

Referring now to FIG. 3, the second embodiment of the hydraulic control system 166 includes fluid lines 176, directional valve 178, and an accumulator 198 disposed in fluid communication with the fluid line 176B for storing pressurized hydraulic fluid. More specifically, the accumulator 198 is adapted to store hydraulic fluid under certain operating conditions of the automatic transmission 14 so that pressurized fluid energy can subsequently be made available at the fluid line 176B under different operating conditions of the automatic transmission 14. The accumulator 198 is a conventional gas-charged hydraulic accumulator, but those having ordinary skill in the art will appreciate that the accumulator 198 could be of any suitable type, or could be omitted entirely, without departing from the scope of the present invention. In one embodiment, an accumulator check valve 200 is used to prevent back-flow of fluid from the accumulator 198 toward the sump 184 and from the accumulator 198 toward the switching valve 178. It should be appreciated that the directional valve 178 includes the valve member 180, spring 182, and hydraulic switch inlet 183 and the valve member 180 has at least three positions. It should also be appreciated that the operation of the directional valve 178 is similar to the directional valve 78 except for the positions summarized below that direct fluid flow in the multi-pressure hydraulic control circuit 166.

The summary of positions for fluid flow of the directional valve 178 illustrated in FIG. 3 is as follows:

| Directional | | | |
|---|---|---|---|
| Valve State | P1 | P2 | P2 |
| Left position | Actuator 2 | Actuator 1 | Lube/Cooling |
| Mid position | Lube/Cooling | Lube/Cooling | Lube/Cooling |
| Right position | Actuator 2 | Sump | Lube/Cooling |

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the invention may be practiced other than as specifically described.

1. A directional valve (78, 178) for use with a multi-pressure hydraulic control system (66, 166) of a vehicle powertrain system (10), said directional valve (78, 178) comprising:
a valve member (80, 180) receiving at least three separate outputs (42) of fluid pumped by at least one pump (28) as fluid inlets to said directional valve (78, 178) and producing at least three fluid outputs for allowing the at least three separate outputs (42) to be selectively combined and/or separated, said valve member (80, 180) being movable between at least three positions that produces the at least three fluid outputs from said directional valve (78, 178) having fluid pressures of a high fluid pressure, a medium fluid pressure, and a low fluid pressure to one or more portions of the hydraulic control system (66, 166).

2. A directional valve (178) as set forth in claim 1 including a fluid accumulator (198) fluidly communicating with at least one of said at least three fluid outputs and with one or more portions of the hydraulic control system (166).

3. A directional valve (78, 178) as set forth in claim 1 wherein one of said at least three fluid outputs having the high fluid pressure fluidly communicates with a first actuator portion (68) of the hydraulic control system (66, 166).

4. A directional valve (78, 178) as set forth claim 3 wherein one of said at least three fluid outputs having the medium fluid pressure fluidly communicates with a second actuator portion (70) of the hydraulic control system (66, 166).

5. A directional valve (78, 178) as set forth in claim 3 wherein one of said at least three fluid outputs having the low fluid pressure fluidly communicates with a lubrication/cooling portion (72) of the hydraulic control system (66, 166).

6. (canceled)

7. A directional valve (178) as set forth in claim 2 wherein said fluid accumulator (198) is fluidly connected to one of said at least three fluid outputs having the medium fluid pressure.

8. (canceled)

9. (canceled)

10. (canceled)

11. A directional valve (78, 178) as set forth in claim 1 wherein said valve member (80, 180) has a left position for directing fluid output having the high fluid pressure to a second actuator portion (70), fluid output having the medium fluid pressure to a first actuator portion (68), and fluid output having the low fluid pressure to a lube/cooling portion (72) of the hydraulic control system (66, 166).

12. A directional valve (78, 178) as set forth in claim 1 wherein said valve member (80, 180) has a mid position for directing fluid output having the high fluid pressure, the medium fluid pressure, and the low fluid pressure to a lubrication/cooling portion (72) of the hydraulic control system (66, 166).

13. A directional valve (78, 178) as set forth in claim 1 wherein said valve member (80, 180) has a right position for directing fluid output of the high fluid pressure to a second actuator portion (70), fluid output of the medium fluid pressure to a sump portion (84, 184), and fluid output of the low fluid pressure to a lubrication/cooling portion (72) of the hydraulic control system (66, 166).

14. A directional valve (78, 178) as set forth in claim 2 wherein said valve member (80, 180) has a left position for directing fluid output of the high fluid pressure, the medium fluid pressure, and the low fluid pressure to a first actuator portion (68) of the hydraulic control system (66, 166).

15. A directional valve (78, 178) as set forth in claim 2 wherein said valve member (80, 180) has a mid position for directing fluid output of the high fluid pressure to a first actuator portion (68), fluid output of the medium fluid pressure to the first actuator portion (68), and the low fluid pressure to a lubrication/cooling portion (72) of the hydraulic control system (66, 166).

16. A directional valve (78, 178) as set forth in claim 2 wherein said valve member (80, 180) has a right position for directing fluid output of the high fluid pressure to a first actuator portion (68), fluid output of the medium fluid pressure to a sump portion (84, 184), and fluid output of the low fluid pressure to a lubrication/cooling portion (72) of the hydraulic control system (66, 166).

17. A method for controlling a directional valve (78, 178) of a multi-pressure hydraulic control system (66, 166) of a vehicle powertrain (10), said method comprising the steps of:
providing a directional valve (78, 178) having a valve member (80, 180) being movable between at least three positions; and
receiving at least three separate outputs (42) of fluid pumped by at least one pump (28) as fluid inlets to the valve member (80, 180) and producing at least three fluid outputs, and moving the valve member (80, 180) between the at least three positions to produce the at least three fluid outputs from the directional valve (78, 178) having a high fluid pressure, a medium fluid pressure, and a low fluid pressure to one or more portions of the hydraulic control system (66, 166).

18. A method as set forth in claim 17 including the step of providing a fluid accumulator (198) and fluidly communicating the fluid accumulator (198) with at least one of the three fluid outputs and with one or more portions of the hydraulic control system (166).

19. A method as set forth in claim 17 including the step of fluidly communicating one of the at least three fluid outputs having the high fluid pressure with a first actuator portion (68) of the hydraulic control system (66, 166).

20. A method as set forth in claim 17 including the step of fluidly communicating one of the at least three fluid outputs having the medium fluid pressure with a second actuator portion (70) of the hydraulic control system (66, 166).

21. A method as set forth in claim 17 including the step of fluidly communicating one of the at least three fluid outputs having the low fluid pressure with a lubrication/cooling portion (72) of the hydraulic control system (66, 166).

22. A method as set forth in claim 18 including the step of fluidly connecting the fluid accumulator (198) to one of the at least three fluid outputs having the medium fluid pressure.

23. A method as set forth in claim 17 including the step of moving the valve member (80, 180) to a left position and directing fluid output of the high fluid pressure to a second actuator portion (70), fluid output of the medium fluid pressure to a first actuator portion (68), and fluid output of the low fluid pressure to a lubrication/cooling portion (72) of the hydraulic control system (66, 166).

24. A method as set forth in claim 17 including the step of moving the valve member (80, 180) to a mid position and directing fluid output of the high fluid pressure, the medium fluid pressure, and the low fluid pressure to a lubrication/cooling portion (72) of the hydraulic control system (66, 166).

25. A method as set forth in claim 17 including the step of moving the valve member (80, 180) to a right position and directing fluid output of the high fluid pressure to a second actuator portion (70), fluid output of the medium fluid pressure to a sump portion (84, 184), and fluid output of the low fluid pressure to a lubrication/cooling portion (72) of the hydraulic control system (66, 166).

26. A method as set forth in claim 22 including the step of moving the valve member (80, 180) to a left position and directing fluid output of the high fluid pressure, the medium fluid pressure, and the low fluid pressure to a first actuator portion (68) of the hydraulic control system (66, 166).

27. A method as set forth in claim 22 including the step of moving the valve member (80, 180) to a mid position and directing fluid output of the high fluid pressure to a first actuator portion (68), fluid output of the medium fluid pressure to the first actuator portion (68), and the low fluid pressure to a lubrication/cooling portion (72) of the hydraulic control system (66, 166).

28. A method as set forth in claim 22 including the step of moving the valve member (80, 180) to a right position and directing fluid output of the high fluid pressure to a first actuator portion (68), fluid output of the medium fluid pressure to a sump portion (84, 184), and fluid output of the low fluid pressure to a lubrication/cooling portion (72) of the hydraulic control system (66, 166).
